(19) United States
(12) Patent Application Publication
(10) Pub. No.: US 2026/0046675 A1
(43) Pub. Date: Feb. 12, 2026

(54) SYSTEM AND METHOD FOR WIRELESS IN-DEVICE INTERFERENCE MITIGATION

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US); Sudhir Srinivasa, Los Gatos, CA (US)

(21) Appl. No.: 19/295,342

(22) Filed: Aug. 8, 2025

Related U.S. Application Data
(60) Provisional application No. 63/681,470, filed on Aug. 9, 2024.
(60) Provisional application No. 63/682,397, filed on Aug. 13, 2024.
(60) Provisional application No. 63/703,423, filed on Oct. 4, 2024.
(60) Provisional application No. 63/712,516, filed on Oct. 27, 2024.
(60) Provisional application No. 63/716,573, filed on Nov. 5, 2024.

(51) Int. Cl. H04W 28/02; H04L 1/1607; H04W 52/02; H04W 84/12

(52) U.S. Cl. CPC H04W 28/0236; H04L 1/1621; H04W 52/0238; H04W 84/12

(57) ABSTRACT

Embodiments of a method and apparatus for wireless communications are disclosed. In an embodiment, a wireless device includes a controller configured to generate a frame that includes one or multiple types of feedbacks indicating unavailability of the wireless device and a wireless transceiver configured to wirelessly transmit the frame.

### CROSS-REFERENCE TO RELATED APPLICATIONS

This application is entitled to the benefit of U.S. Provisional Patent Application Ser. No. 63/681,470, filed on Aug. 9, 2024, U.S. Provisional Patent Application Ser. No. 63/682,397, filed on Aug. 13, 2024, U.S. Provisional Patent Application Ser. No. 63/703,423, filed on Oct. 4, 2024, U.S. Provisional Patent Application Ser. No. 63/712,516, filed on Oct. 27, 2024, and U.S. Provisional Patent Application Ser. No. 63/716,573, filed on Nov. 5, 2024, the contents of which are incorporated by reference herein in their entireties.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. Wireless communications interference affects wireless communication throughput. For example, wireless transmissions of in-device coexisting (IDC) radio(s), such as, a Bluetooth transmitter interferes with wireless transmissions of a WLAN (e.g., Wi-Fi) transmitter.

### SUMMARY

Embodiments of a method and apparatus for wireless communications are disclosed. In an embodiment, a wireless device includes a controller configured to generate a frame that includes one or multiple types of feedbacks indicating unavailability of the wireless device and a wireless transceiver configured to wirelessly transmit the frame. Other embodiments are also disclosed.

In an embodiment, each type of feedback of the one or multiple types of feedbacks is carried in its own feedback field, and a feedback field in a Buffer Status Report Poll (BSRP) trigger frame includes a Feedback User Information (Info) field.

In an embodiment, B12 to B15 of the Feedback User Info field indicate a type of a feedback in the Feedback User Info field, and B16 to B39 of the Feedback User Info field carry the feedback and optional reserved bits.

In an embodiment, the feedback includes unavailability information that indicates an unavailable time period of the wireless device as a result of an existence or an occurrence of a wireless communications interference within the wireless device.

In an embodiment, each type of feedback of the one or multiple types of feedbacks is carried in its own feedback field, and a feedback field in a Multi-Station (STA) Block Acknowledgement (BA) frame includes a Feedback Per Association Identification (ID) (AID) Traffic Identifier (TID) Information (Info) field.

In an embodiment, 4 bits of Block Acknowledgement Starting Sequence Control indicate a type of a feedback in the Feedback Per AID TID Info field, and a Block Acknowledgement Bitmap field of in the Feedback Per AID TID Info field is repurposed to carry the feedback and optional reserved bits.

In an embodiment, the feedback includes unavailability information that indicates an unavailable time period of the wireless device as a result of an existence or an occurrence of a wireless communications interference within the wireless device.

In an embodiment, the one or multiple types of feedbacks indicate the unavailability of the wireless device and/or the other type of feedbacks of the wireless device, and the other type of feedbacks of the wireless device include a bandwidth (BW) and number of spatial streams (Nss) of a dynamic power save (DPS) station (STA) that a DPS assisting AP intend to use for frame exchanges with the DPS STA or an internal interference indication that is used to indicate whether a reason that frames in a received Aggregated MAC Protocol Data Unit (A-MPDU) are not received correctly is an internal interference.

In an embodiment, the wireless device includes a wireless access point (AP) that maintains at most one availability information of each station (STA).

In an embodiment, when the wireless AP receives new unavailability information from a STA, the wireless AP discards previous unavailability information from the STA and maintains the new unavailability information from the STA.

In an embodiment, the frame includes an initial control response (ICR) frame, and a Common Information field of an initial control frame (ICF) frame soliciting the ICR frame indicates whether or not the ICR frame is transmitted in a non-high throughput (HT) duplicate PPDU Physical Layer Protocol Data Unit (PPDU).

In an embodiment, the ICF frame includes a Buffer Status Report Poll (BSRP) trigger frame, and the ICR frame includes a Multi-Station (STA) Block Acknowledgement (BA) frame.

In an embodiment, the wireless device is compatible with an Institute of Electrical and Electronics Engineers (IEEE) 802.11 protocol.

In an embodiment, the wireless device includes a wireless multi-link device (MLD), and the wireless transceiver is further configured to transmit the frame to a second wireless MLD through a wireless link between the wireless MLD and the second wireless MLD.

In an embodiment, a method for wireless communications includes at a wireless device, generating a frame that includes one or multiple types of feedbacks indicating unavailability of the wireless device and from the wireless device, wirelessly transmitting the frame.

In an embodiment, each type of feedback of the one or multiple types of feedbacks is carried in its own feedback field, and a feedback field in a Buffer Status Report Poll (BSRP) trigger frame includes a Feedback User Information (Info) field.

In an embodiment, B12 to B15 of the Feedback User Info field indicate a type of a feedback in the Feedback User Info field, and B16 to B39 of the Feedback User Info field carry the feedback and optional reserved bits.

In an embodiment, the feedback includes unavailability information that indicates an unavailable time period of the wireless device as a result of an existence or an occurrence of a wireless communications interference within the wireless device.

In an embodiment, each type of feedback of the one or multiple types of feedbacks is carried in its own feedback field, and a feedback field in a Multi-Station (STA) Block Acknowledgement (BA) frame includes a Feedback Per Association Identification (ID) (AID) Traffic Identifier (TID) Information (Info) field.

In an embodiment, 4 bits of Block Acknowledgement Starting Sequence Control indicate a type of a feedback in the Feedback Per AID TID Info field, and a Block Acknowledgement Bitmap field of in the Feedback Per AID TID Info field is repurposed to carry the feedback and optional reserved bits.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 depicts a wireless device with multiple wireless transceivers in accordance with an embodiment of the invention.

FIG. 5 illustrates a frame format in accordance with an embodiment of the invention.

FIG. 6 illustrates a Feedback User Information (Info) Field format in accordance with an embodiment of the invention.

FIG. 7 illustrates a Feedback Per Association Identification (ID) (AID) Traffic Identifier (TID) Info field format in accordance with an embodiment of the invention.

FIG. 8 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

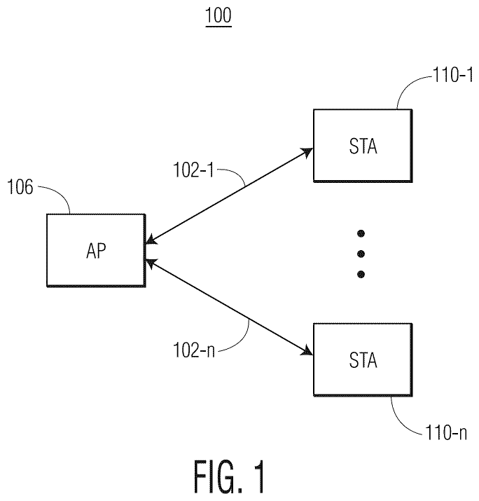

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

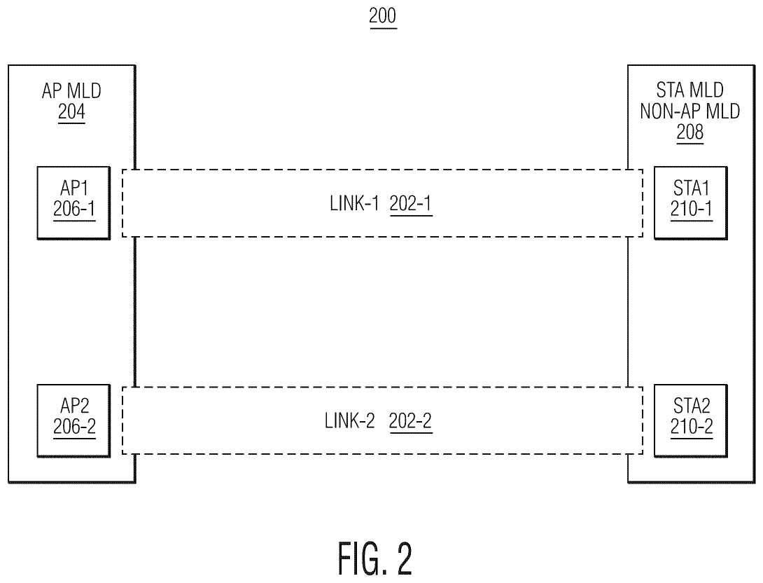

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

A wireless communications interference, such as In-device coexisting (IDC) radio(s) (e.g., a Bluetooth transmitter), may interfere with a WLAN (e.g., Wi-Fi) transmitter because the WLAN (e.g., Wi-Fi) transmitter might not know for periodic activity or might not know for aperiodic activity beforehand when the interference may occur. A WLAN (e.g., Wi-Fi) device can announce that the device has one or more coexisting radios/transmitters when performing the association or after the in-device coexisting (IDC) radio(s) is turned on or turned off. In some embodiments, the activity of coexisting radios/transmitters are link-level information. This information can help its connected WLAN (e.g., Wi-Fi) device to optimize rate adaptation in transmission. Knowing that a WLAN (e.g., Wi-Fi) receiver's error packets are resulted from a coexisting interference instead of a bad channel condition can improve wireless transmission throughput, for example, by preventing a WLAN (e.g., Wi-Fi) transmitter from dropping data packets, resulting in a lower data rate.

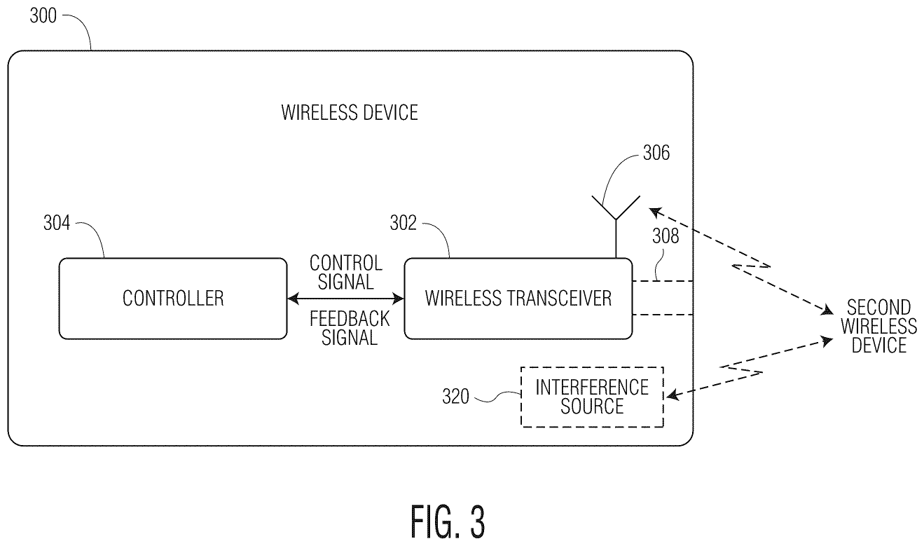

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In some embodiments, an interference source 320 is located within the wireless device. For example, the interference source 320 may be an in-device coexisting (IDC) transmitter/radio (e.g., a Bluetooth transmitter/radio) and/or other known interference source. In some embodiments, the wireless device 300 may further include a second wireless transceiver, and the interference source includes the second wireless transceiver. In some embodiments, the wireless transceiver 302 is compatible with an Institute of Electrical and Electronics Engineers (IEEE) 802.11 protocol, while the second wireless transceiver is not compatible with the IEEE 802.11 protocol. For example, the second wireless transceiver may be compatible with a short range wireless communications protocol (e.g., a Bluetooth communications protocol).

In some cases, a device can solicit its peer device's availability information and unavailability information. A device can report its availability information and unavailability information. A Buffer Status Report Poll (BSRP) trigger frame and a multi-STA Block Acknowledgement (Ack) (BA) frame can be the initial control frame (ICF) and the initial control response (ICR) frame. A Multi-user (MU)-Request to Send (RTS) frame can be an ICF when no feedback (e.g., available and unavailability information) is reported by the peer device.

In accordance with an embodiment of the invention, the controller 304 is configured to generate a frame that includes one or multiple types of feedbacks indicating unavailability of the wireless device 300 and the wireless transceiver 302 is configured to wirelessly transmit the frame, for example, through the at least one antenna 306. In some embodiments, each type of feedback of the one or multiple types of feedbacks is carried in its own feedback field, and wherein a feedback field in a Buffer Status Report Poll (BSRP) trigger frame includes a Feedback User Information (Info) field. In some embodiments, B12 to B15 of the Feedback User Info field indicate a type of a feedback in the Feedback User Info field, and B16 to B39 of the Feedback User Info field carry the feedback and optional reserved bits. In some embodiments, the feedback includes unavailability information that indicates an unavailable time period of the wireless device as a result of an existence or an occurrence of a wireless communications interference within the wireless device. In some embodiments, each type of feedback of the one or multiple types of feedbacks is carried in its own feedback field, and a feedback field in a Multi-Station (STA) Block Acknowledgement (BA) frame includes a Feedback Per Association Identification (ID) (AID) Traffic Identifier (TID) Information (Info) field. In some embodiments, 4 bits of Block Acknowledgement Starting Sequence Control indicate a type of a feedback in the Feedback Per AID TID Info field, and a Block Acknowledgement Bitmap field of in the Feedback Per AID TID Info field is repurposed to carry the feedback and optional reserved bits. In some embodiments, the feedback includes unavailability information that indicates an unavailable time period of the wireless device as a result of an existence or an occurrence of a wireless communications interference within the wireless device. In some embodiments the one or multiple types of feedbacks indicate the unavailability of the wireless device and/or the other type of feedbacks of the wireless device, and the other type of feedbacks of the wireless device include the bandwidth (BW) and number of spatial streams (Nss) of a dynamic power save (DPS) station (STA) that a DPS assisting AP intend to use for frame exchanges with the DPS STA (with such announcement, the DPS STA does not need to use its full functional BW and Nss for the frame exchanges with the DPS Assisting AP) and/or an internal interference indication that is used to indicate whether the reason that frames in a received Aggregated MAC Protocol Data Unit (A-MPDU) are not received correctly is an internal interference. In some embodiments, the wireless device includes a wireless access point (AP) or a wireless non-AP station (STA). In some embodiments, the wireless device includes a wireless access point (AP) that maintains at most one availability information of each station (STA). In some embodiments, when the wireless AP receives new unavailability information from a STA, the wireless AP discards previous unavailability information from the STA and maintains the new unavailability information from the STA. In some embodiments, the frame includes an initial control response (ICR) frame, and a Common Information field of an initial control frame (ICF) frame soliciting the ICR frame indicates whether or not the ICR frame is transmitted in a non-high throughput (HT) duplicate PPDU Physical Layer Protocol Data Unit (PPDU). In some embodiments, the ICF frame includes a Buffer Status Report Poll (BSRP) trigger frame, and the ICR frame includes a Multi-Station (STA) Block Acknowledgement (BA) frame. In some embodiments, the controller 304 is configured to generate a frame that includes unavailability information of the wireless device 300 as a result of an existence or an occurrence of a wireless communications interference (e.g., the interference source 320) within the wireless device 300, and the wireless transceiver 302 is configured to wirelessly transmit the frame, for example, through the at least one antenna 306. In some embodiments, the unavailability information of the wireless device includes information that indicates an unavailable time period of the wireless device as the result of the existence or the occurrence of the wireless communications interference (e.g., the interference source 320) within the wireless device. In some embodiments, the information that indicates the unavailable time period of the wireless device includes an unavailable start time or an unavailable duration when a first transmitter (e.g., the wireless transceiver 302) of the wireless device is not available because of an activity of a second transmitter (e.g., the interference source 320) of the wireless device. In some embodiments, the first transmitter and the second transmitter are of different types. In some embodiments, the first transmitter (e.g., the wireless transceiver 302) is compatible with an Institute of Electrical and Electronics Engineers (IEEE) 802.11 protocol, and the second transmitter (e.g., the interference source 320) is compatible with a short range wireless communications protocol. In some embodiments, the short range wireless communications protocol includes a Bluetooth communications protocol. In some embodiments, the controller 304 is further configured to generate a second frame that includes updated unavailability information of the wireless device as a result of an existence or an occurrence of a second wireless communications interference (e.g., the interference source 320) within the wireless device, and the wireless transceiver 302 is further configured to wirelessly transmit the second frame. In some embodiments, a device (e.g., an AP) maintains a single unavailable information of its peer device (e.g., an associated STA) in which case when a new/current unavailable information is acquired from a peer device, the old/previous unavailable information from the peer device is deleted or removed. In some embodiments, the unavailability information is contained in a feedback user information field of the frame. In some embodiments, the unavailability information is contained in a feedback per Association Identification (ID) (AID) Traffic Identifier (TID) information field of the frame. In some embodiments, the frame includes an initial control frame (ICF) or an initial control response (ICR) frame. In some embodiments, the frame includes an ICR frame, and a Common Information field of the ICR frame indicates whether the ICR frame is located in a non-high throughput (HT) duplicate PPDU Physical Layer Protocol Data Unit (PPDU). In some embodiments, the wireless device includes a mobile wireless access point (AP) or a wireless non-AP station (STA). In some embodiments, the wireless device is compatible with an Institute of Electrical and Electronics Engineers (IEEE) 802.11 protocol. In some embodiments, the wireless device includes a wireless multi-link device (MLD), and the wireless transceiver is further configured to transmit the frame to a second wireless MLD through a wireless link between the wireless MLD and the second wireless MLD.

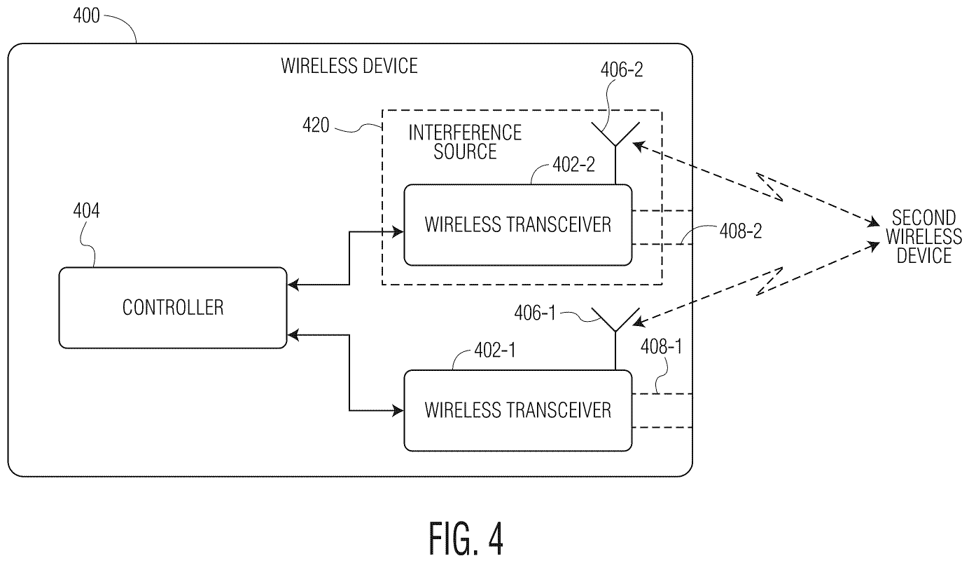

FIG. 4 depicts a wireless device 400 with multiple wireless transceivers 402-1, 402-2 in accordance with an embodiment of the invention. The wireless device 400 depicted in FIG. 4 may be an embodiment of the wireless device 300 depicted in FIG. 3. However, the wireless device 300 depicted in FIG. 3 is not limited to the embodiment depicted in FIG. 4. The wireless device 400 can be used in the wireless communications system 100 depicted in FIG. 1 and/or the multi-link communications system 200 depicted in FIG. 2. For example, the wireless device 400 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 4, the wireless device 400 includes the first wireless transceiver 402-1, the second wireless transceiver 402-2, a controller 404 operably connected to the wireless transceiver, a first antenna 406-1 operably connected to the first wireless transceiver 402-1, and a second antenna 406-2 operably connected to the second wireless transceiver 402-2. In some embodiments, the wireless device 400 may include one or more optional network ports 408-1, 408-2 operably connected to the wireless transceivers 402-1, 402-2. In some embodiments, at least one of the wireless transceivers 402-1, 402-2 includes a physical layer (PHY) device. The wireless transceivers 402-1, 402-2 may be any suitable type of wireless transceiver. For example, one of the wireless transceivers 402-1, 402-2 may be a WLAN transceiver (e.g., a transceiver compatible with an IEEE 802.11 protocol) while another one of the wireless transceivers 402-1, 402-2 may be a short-range transceiver (e.g., a transceiver compatible with a Bluetooth communications protocol). The controller may be configured to control the wireless transceivers 402-1, 402-2 (e.g., by generating one or more control signals) to process packets received through the antennas 406-1, 406-2 and/or the network ports 408-1, 408-2 and/or to generate outgoing packets to be transmitted through the antennas 406-1, 406-2 and/or the network ports 408-1, 408-2. In some embodiments, the wireless transceivers 402-1, 402-2 transmits one or more feedback signals to the controller 404. In some embodiments, the controller is implemented within a processor, such as a microcontroller, a host processor, a host, a DSP, or a CPU. In some embodiments, at least one of the wireless transceivers 402-1, 402-2 is implemented in hardware (e.g., circuits), software, firmware, or a combination thereof. The antenna may be any suitable type of antenna. For example, at least one of the antennas 406-1, 406-2 may be an induction type antenna such as a loop antenna or any other suitable type of induction type antenna. However, the antennas 406-1, 406-2 are not limited to induction type antennas. The network ports 408-1, 408-2 may be any suitable type of ports. For example, at least one of the network ports 408-1, 408-2 is an LAN port (e.g., an Ethernet port). Although the depicted wireless device 400 is shown in FIG. 4 with certain components and described with certain functionality herein, other embodiments of the wireless device 400 may include fewer or more components to implement the same, less, or more functionality. For example, although the wireless device 400 is shown in FIG. 4 as being connected in a certain topology, the network topology of the wireless device 400 is not limited to the topology shown in FIG. 4. In another example, in some embodiments, the wireless device includes multiple controllers with multiple wireless transceivers, a single antenna, more than two wireless transceivers, more than one antennas, and/or more than two network ports.

In some embodiments, the controller 404 is configured to generate a frame (e.g., a Physical Layer Convergence Protocol (PLCP) Service Data Unit (PSDU) carried in a PLCP Protocol Data Unit (PPDUs), a control frame, a beacon frame, or a management frame, etc.) that includes interference information indicating an existence or an occurrence of a wireless communications interference and the wireless transceiver 402-1 is configured to transmit the frame through the antenna 406-1. In some embodiments, the wireless device 400 is a wireless access point (AP) or a non-AP wireless station (STA) device. In some embodiments, the wireless device 400 is a component of a multi-link device (MLD)'s link.

In some embodiments, an interference source 420 is located within the wireless device 400 (e.g., a link of wireless device in the wireless device is a MLD with more than one link). For example, the interference source 420 may be an in-device coexisting (IDC) transceiver/radio (e.g., a Bluetooth transceiver/radio) and/or other known interference source. In some embodiments, the wireless device further includes the second wireless transceiver 402-2, and the interference source 420 includes the second wireless transceiver 402-2 and/or the second antenna 406-2. In some embodiments, the first wireless transceiver 402-1 is compatible with an Institute of Electrical and Electronics Engineers (IEEE) 802.11 protocol, and the second wireless transceiver 402-2 is not compatible with the IEEE 802.11 protocol. In some embodiments, the second wireless transceiver 402-2 is compatible with a short range wireless communications protocol (e.g., a Bluetooth communications protocol).

In accordance with an embodiment of the invention, the controller 404 is configured to generate a frame that includes one or multiple types of feedbacks indicating unavailability of the wireless device 400 and the wireless transceiver 402-1 is configured to wirelessly transmit the frame, for example, through the at least one antenna 406. In some embodiments, each type of feedback of the one or multiple types of feedbacks is carried in its own feedback field, and wherein a feedback field in a Buffer Status Report Poll (BSRP) trigger frame includes a Feedback User Information (Info) field. In some embodiments, B12 to B15 of the Feedback User Info field indicate a type of a feedback in the Feedback User Info field, and B16 to B39 of the Feedback User Info field carry the feedback and optional reserved bits. In some embodiments, the feedback includes unavailability information that indicates an unavailable time period of the wireless device as a result of an existence or an occurrence of a wireless communications interference within the wireless device. In some embodiments, each type of feedback of the one or multiple types of feedbacks is carried in its own feedback field, and a feedback field in a Multi-Station (STA) Block Acknowledgement (BA) frame includes a Feedback Per Association Identification (ID) (AID) Traffic Identifier (TID) Information (Info) field. In some embodiments, 4 bits of Block Acknowledgement Starting Sequence Control indicate a type of a feedback in the Feedback Per AID TID Info field, and a Block Acknowledgement Bitmap field of in the Feedback Per AID TID Info field is repurposed to carry the feedback and optional reserved bits. In some embodiments, the feedback includes unavailability information that indicates an unavailable time period of the wireless device as a result of an existence or an occurrence of a wireless communications interference within the wireless device. In some embodiments the one or multiple types of feedbacks indicate the unavailability of the wireless device and/or the other type of feedbacks of the wireless device, and the other type of feedbacks of the wireless device include the bandwidth (BW) and number of spatial streams (Nss) of a dynamic power save (DPS) station (STA) that a DPS assisting AP intend to use for frame exchanges with the DPS STA (with such announcement, the DPS STA does not need to use its full functional BW and Nss for the frame exchanges with the DPS Assisting AP) and/or an internal interference indication that is used to indicate whether the reason that frames in a received Aggregated MAC Protocol Data Unit (A-MPDU) are not received correctly is an internal interference. In some embodiments, the wireless device includes a wireless access point (AP) or a wireless non-AP station (STA). In some embodiments, the wireless device includes a wireless access point (AP) that maintains at most one availability information of each station (STA). In some embodiments, when the wireless AP receives new unavailability information from a STA, the wireless AP discards previous unavailability information from the STA and maintains the new unavailability information from the STA. In some embodiments, the frame includes an initial control response (ICR) frame, and a Common Information field of an initial control frame (ICF) frame soliciting the ICR frame indicates whether or not the ICR frame is transmitted in a non-high throughput (HT) duplicate PPDU Physical Layer Protocol Data Unit (PPDU). In some embodiments, the ICF frame includes a Buffer Status Report Poll (BSRP) trigger frame, and the ICR frame includes a Multi-Station (STA) Block Acknowledgement (BA) frame. In some embodiments, the controller 404 is configured to generate a frame that includes unavailability information of the wireless device 400 as a result of an existence or an occurrence of a wireless communications interference (e.g., the interference source 420) within the wireless device 400, and the wireless transceiver 402-1 is configured to wirelessly transmit the frame, for example, through at least one antenna 406-1. In some embodiments, the unavailability information of the wireless device 400 includes information that indicates an unavailable time period of the wireless device as the result of the existence or the occurrence of the wireless communications interference (e.g., the interference source 420) within the wireless device. In some embodiments, the information that indicates the unavailable time period of the wireless device includes an unavailable start time or an unavailable duration when a first transmitter (e.g., the wireless transceiver 402-1) of the wireless device 400 is not available because of an activity of a second transmitter (e.g., the wireless transceiver 402-2) of the wireless device 400. In some embodiments, the first transmitter (e.g., the wireless transceiver 402-1) and the second transmitter (e.g., the wireless transceiver 402-2) are of different types. In some embodiments, the first transmitter (e.g., the wireless transceiver 402-1) is compatible with an Institute of Electrical and Electronics Engineers (IEEE) 802.11 protocol, and the second transmitter (e.g., the wireless transceiver 402-2) is compatible with a short range wireless communications protocol. In some embodiments, the short range wireless communications protocol includes a Bluetooth communications protocol. In some embodiments, the controller 404 is further configured to generate a second frame that includes updated unavailability information of the wireless device as a result of an existence or an occurrence of a second wireless communications interference (e.g., the interference source 420) within the wireless device 400, and the wireless transceiver 402-1 is further configured to wirelessly transmit the second frame. In some embodiments, the unavailability information is contained in a feedback user information field of the frame. In some embodiments, the unavailability information is contained in a feedback per Association Identification (ID) (AID) Traffic Identifier (TID) information field of a Multi-STA BA frame. In some embodiments, the unavailability information is contained in a feedback User Info field of a BSRP Trigger frame. In some embodiments, the frame includes an initial control frame (ICF) or an initial control response (ICR) frame. In some embodiments, the frame includes an ICR frame, and a Common Information field of the ICF frame that solicits ICR indicates whether the responding ICR frame is located in a non-high throughput (HT) duplicate PPDU Physical Layer Protocol Data Unit (PPDU). In some embodiments, the wireless device 400 includes an AP (e.g., a mobile wireless access point (AP)) or a wireless non-AP station (STA). In some embodiments, the wireless device 400 is compatible with an Institute of Electrical and Electronics Engineers (IEEE) 802.11 protocol. In some embodiments, the wireless device 400 includes a wireless multi-link device (MLD), and the wireless transceiver 402-1 is further configured to transmit the frame to a second wireless MLD through a wireless link between the wireless MLD and the second wireless MLD.

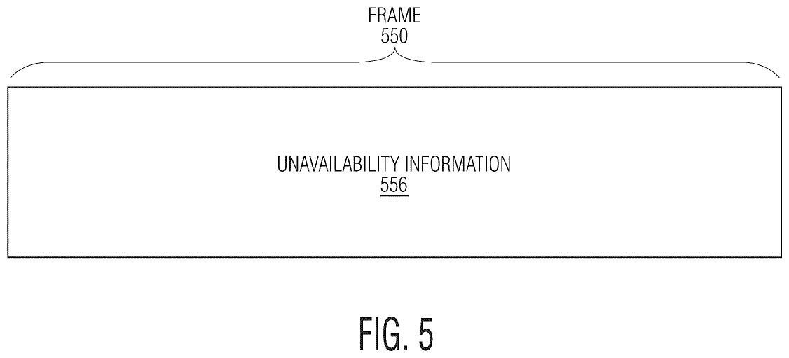

FIG. 5 illustrates a frame format 550 in accordance with an embodiment of the invention. The frame format 550 illustrated in FIG. 5 can be used for communications by the wireless communications system 100 depicted in FIG. 1, the multi-link (ML) communications system 200 depicted in FIG. 2, the wireless device 300 depicted in FIG. 3, and/or the wireless device 400 depicted in FIG. 4. In the embodiment depicted in FIG. 5, the frame format 550 contains unavailability information 556 of a wireless device as a result of an existence or an occurrence of a wireless communications interference within the wireless device besides the MAC header, Frame Check Sequence (FCS) and the other fields that are not shown in FIG. 5. In some embodiments, the unavailability information 556 of the wireless device includes information that indicates an unavailable time period of the wireless device as a result of an existence or an occurrence of a wireless communications interference within the wireless device. In some embodiments, the unavailability information 556 of the wireless device includes time period information (e.g., unavailable start time and/or an unavailable duration) when the main type of radio (e.g., Wi-Fi radio) of the wireless device is not available because of an activity of another type of radio of the wireless device.

In some embodiments, the frame format 550 includes a header that contains header information (not shown in FIG. 5) and a frame body that contains frame body data, e.g., unavailable information and optional other fields. In some embodiments, the frame format 550 contains one or more additional fields with additional information. In some embodiments, the frame format 550 also includes an FCS (not shown in FIG. 5). The unavailability information 556 can be included in the header, the frame body, and/or an additional field of the frame format 550. In some embodiments, the frame 550 is a management frame or a control frame.

Some implementations of unavailability information in an ICF and/or an ICR frame, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described.

In some embodiments, the unavailability information indicates the time period (e.g., unavailable start time, unavailable duration) when the main type of radio (e.g., Wi-Fi radio) in a device is not available because of another type of radio (e.g., Bluetooth radio)'s activity. In some embodiments, the Duration field in an ICF and/or an ICR frame indicates the remaining time of a transmit opportunity (TXOP) and is decoupled from the availability information.

Some implementations of ICF and ICR for multiple feedbacks, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described.

In some embodiments, both a BSRP trigger frame as an ICF and a Multi-STA BA frame as an ICR frame can carry multiple types of feedback information, e.g., availability information, and Tx/Rx parameter restriction (e.g., bandwidth (BW), number of spatial streams (Nss) etc.)

In some embodiments, either a STA (e.g., a non-AP STA) or an AP can transmit BSRP with feedback information. The AP can be a mobile AP only or one of a mobile AP and a regular AP.

In some embodiments, a TXOP with an ICF carries the feedback. In some embodiments, the control frame exchange with the BSRP Trigger to carry the unavailability information that is the first frame exchange in a TXOP may be the only frame exchange of the TXOP. In some embodiments, the control frame exchange with the BSRP Trigger to carry the unavailability information that is the first frame exchange in a TXOP may be followed by the other frame exchanges in the TXOP.

Some implementations of updating unavailability information, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described.

In some embodiments, a device that announced its unavailability information may have changed unavailable information, for example, before the start time of the unavailable duration or within the unavailable duration. In some embodiments, the device announces its new unavailability information to replace the old/previous availability information. In some embodiments, at any time, a device maintains at most one unavailability information (e.g., unavailable start time, unavailable duration) for each peer device.

Some implementations of independent support of Tx and Rx of unavailability information, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described.

In some embodiments, in Option 1, a STA or an AP announces the following information together, which includes whether it supports the transmission of unavailability information without soliciting control frame and whether it supports the transmission of unavailability information after receiving the soliciting control frame.

In some embodiments, in Option 2, a STA or an AP announces the following independently, which includes whether it supports the transmission of unavailability information without soliciting control frame and whether it supports the transmission of unavailability information after receiving the soliciting control frame.

Some implementations of releasing unused TXOP time, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described.

In some embodiments, in a TXOP with an AP as the TXOP holder, if/when a TXOP responder reports its available time earlier than the end time of the TXOP selected by the AP, the TXOP holder may perform the frame exchanges with the other STAs. In some embodiments, if the AP cannot use the whole TXOP, the AP may transmit a Contention Free-End (CF-End) to release the reserved medium time. In some embodiments, when the TXOP responder reports its available time that is earlier than the end time of the TXOP, the TXOP holder may send the CF-End frame to release the remaining time of the TXOP if the following condition is true: the PPDU carrying the Contention Free-End (CF-End) and Extended Interframe space (EIFS) is before the TXOP end time. In some embodiments, the TXOP responder's CF-End is transmitted at 6 megabits per second (Mbps), for example, in a non-High Throughput (HT) duplicate PPDU.

Some implementations of unavailability information and other feedback information in ICF, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described.

In some embodiments, each of unavailability information and the other feedback information is carried in the frame body of an ICF (e.g., a BSRP Trigger frame).

In some embodiments, in Option 1.1, the unavailability information is carried in a Feedback User Info field. In some embodiments, each of the other feedback information is carried in its respective special User Info field whose AID12 field has special value to indicate the type of the carried control information type. In some embodiments, the Feedback User Info field has special value (e.g. >2007) in its AID12 field to indicate that the carried feedback information is feedback. In some embodiments, the Feedback User Info field in a Trigger type has the same length as a Special User Info field if the Special User Info field is in the EHT Trigger frame of the Trigger type. In some embodiments, B12 to B39 of the Feedback User Info field carry feedback information, e.g., Unavailable Start Time (9-bit field), Unavailable Duration (9-bit field) followed by the reserved bits carry the unavailable information.

In some embodiments, in Option 1.2, the unavailability information is carried in a Feedback User Info field. In some embodiments, each of the other feedback information is carried in its respective Feedback User Info field. In some embodiments, the Feedback User Info field has special value (e.g. >2007) in its AID12 field to indicate that the feedback control information is carried. In some embodiments, the Feedback User Info field in a Trigger type has the same length as a Special User Info field if the Special User Info field is in the EHT Trigger frame of the Trigger type. In some embodiments, B12 to B15 of the Feedback User Info field (i.e., B0 to B3 of Feedback Info field) carry Type ID (e.g. 4-bit field) that is Feedback, B16 to B39 (i.e., B4 to B27 of Feedback Info field) carry the feedback information, e.g., Unavailable Start Time (9-bit field), Unavailable Duration (9-bit field) followed by the reserved bits carry the unavailable information.

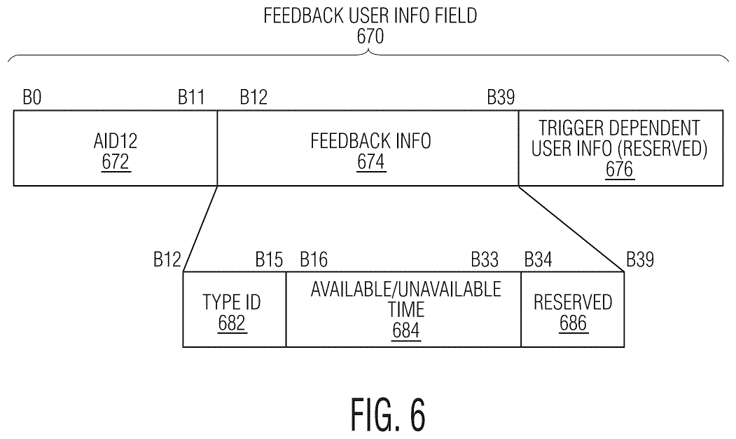

FIG. 6 illustrates a Feedback User Info Field format 670 in accordance with an embodiment of the invention. The Feedback User Info Field format 670 illustrated in FIG. 6 can be used for communications by the wireless communications system 100 depicted in FIG. 1, the multi-link (ML) communications system 200 depicted in FIG. 2, the wireless device 300 depicted in FIG. 3, and/or the wireless device 400 depicted in FIG. 4. In the embodiment depicted in FIG. 6, the Feedback User Info Field format 670 includes an Association Identification (ID) (AID) 12 subfield 672 (e.g., twelve-bit) that may contain Association ID information, a feedback info subfield 674 (e.g., twenty-eight-bit) that may contain feedback information, and a trigger dependent user info/reserved subfield 676 that may contain trigger dependent user information. In some embodiments, the feedback info subfield 674 includes a type ID subfield 682 (e.g., four-bit) that may contain type ID information, an available/unavailable time subfield 684 (e.g., eighteen-bit) that may contain available/unavailable time information if/when the type ID field indicates the unavailable information feedback type or the other feedback if/when the type ID field indicates the other feedback type, and a reserved subfield 686 (e.g., six-bit) that may contain reserved information.

In some embodiments, in Option 2.1, the unavailability time or the other feedback information is carried in a Feedback User Info field. In some embodiments, each of the other feedback information is carried in its respective special User Info field whose AID12 field has special value to indicate the type of the carried control information type. In some embodiments, the Feedback User Info field has special value in its AID8 field to indicate the type of the dynamic control information (feedback type). In some embodiments, the value of AID8 and any value in B8 to B11 are more than 2007 and less than 2047. In some embodiments, the Feedback User Info field has the same length as a Special User Info field if the Special User Info field is in the Trigger frame. In some embodiments, B8 to B39 of the Feedback User Info field carry Feedback Type (e.g. 4-bit field), and if/when the Type ID indicates the unavailable information type, B8 to B39 of the Feedback User Info field also carry Reserved (e.g. 10-bit field), Unavailable Start Time (9-bit field), Unavailable Duration (9-bit field).

Some implementations of available/unavailable time and other feedback information in an ICR frame, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described.

In some embodiments, the unavailable time is defined by an unavailable start time, unavailable time duration.

In some embodiments, the available time is defined by the current time to the unavailable start time.

In some embodiments, each of unavailable time and the other feedback information is carried in the frame body of an ICR frame (e.g., a Multi-STA BA frame).

In some embodiments, in Option 1, the unavailable time is carried in a Feedback Per Association Identification (ID) (AID) Traffic Identifier (TID) Info field. In some embodiments, each type of feedback, i.e., each of the unavailable information and the other dynamic control information is carried in its respective special Per AID TID Info field whose AID11 field has special value to indicate the type of the carried control information type. In some embodiments, the Feedback Per AID TID Info field has special value (e.g. >2007) for each feedback type in its AID11 field to indicate that the carried feedback information is feedback of the respective type. In some embodiments, a 4-octet Block Ack Bitmap subfield of a Feedback User Info field for unavailable information type is repurposed to carry Reserved bits, Unavailable Start Time (9-bit field or 10-bit field), Unavailable Duration (9-bit field or 10-bit field)

In some embodiments, in Option 2, the unavailable time is carried in a Feedback Per AID TID Info field. In some embodiments, the Feedback Per AID TID Info field has special value (e.g. >2007) in its AID11 field to indicate that the feedback information is carried. In some embodiments, a TID subfield of AID TID Info field or a Fragment Number field of Block Ack Starting Sequence Control field in a Feedback Per AID TID Info field carries Type ID (e.g. 4-bit field). In some embodiments, for each type of feedback information in a Feedback User Info field, the Type ID field of the Feedback User Info field indicates the related type. In some embodiments, a 4-octet Block Ack Bitmap subfield of a Feedback User Info field is repurposed to carry the feedback, e.g., for unavailable information, 4-octet Block Ack Bitmap subfield carry Unavailable Start Time (9-bit or 10-bit field), Unavailable Duration (9-bit or 10-bit field) followed by the reserved bits.

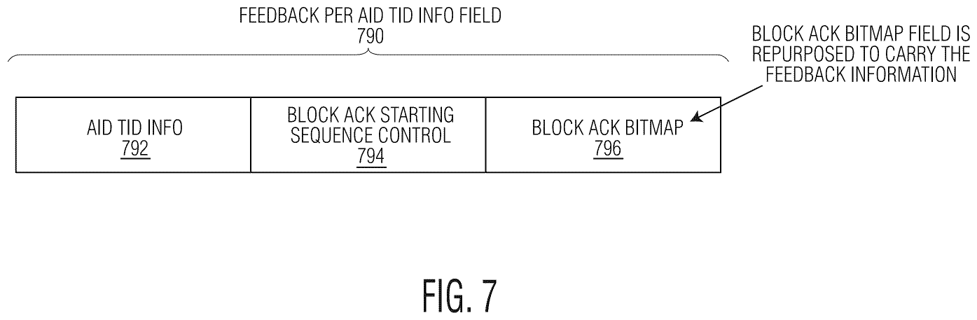

FIG. 7 illustrates a Feedback Per AID TID Info field format 790 in accordance with an embodiment of the invention. The Feedback Per AID TID Info field format 790 illustrated in FIG. 7 can be used for communications by the wireless communications system 100 depicted in FIG. 1, the multi-link (ML) communications system 200 depicted in FIG. 2, the wireless device 300 depicted in FIG. 3, and/or the wireless device 400 depicted in FIG. 4. In the embodiment depicted in FIG. 7, the Feedback Per AID TID Info field format 790 includes an AID TID Info subfield 792 that may contain Association ID information, TID information, and/or the Ack type information, a Block Acknowledgement (BA) Starting Sequence Control subfield 794 that may contain Block Ack Starting Sequence Control information where some bits (e.g., a fragment number field) are repurposed as the Type ID to indicate the type of the feedback, and a Block Ack Bitmap subfield 796 that can be repurposed to carry the feedback information.

Some implementations of a PPDU Carrying an ICR frame, for example, by the wireless communications system 100 depicted in FIG. 1, the multi-link (ML) communications system 200 depicted in FIG. 2, the wireless device 300 depicted in FIG. 3, and/or the wireless device 400 depicted in FIG. 4 are described.

In some embodiments, the Common Info field in a BSRP Trigger frame as an ICF frame indicates whether the ICR frame is in a non-HT duplicate PPDU. In some embodiments, a current reserved information (e.g., a reserved value or a reserved bit) in the Common Info field or the Special User Info field of an ICF is repurposed to indicate whether the solicited PPDU is a non-HT (duplicate) PPDU. In some embodiments, when the soliciting ICF with single addressed STA indicates the responding non-HT (duplicate) PPDU, the single-addressed TXOP responder will transmit an ICR frame in a non-HT (duplicate) PPDU.

In some embodiments, in another variant, when the soliciting ICF with single addressed STA indicates the responding non-HT (duplicate) PPDU, the single-addressed TXOP responder will transmit an ICR frame in a non-HT (duplicate) PPDU with the following exception: If the non-HT duplicate PPDU cannot reach the TXOP holder, the TXOP responder can transmit the ICR frame in an Extended long range (ELR) PPDU or a Trigger-based (TB) PPDU.

In some embodiments, a method of announcing available information and unavailability information by a first device to the second device involves transmitting, by the first device, its available information and unavailability information through an ICF, acknowledging, by a second device, the reception of first device's available information and unavailability information by using an ICR frame addressed to the first device, soliciting, by the first device, the second device's available information and unavailability information through ICF, and responding, by the second device, its available information and unavailability information through the ICR frame. In some embodiments, the ICF is a BSRP Trigger frame when carrying the available information and unavailable information. In some embodiments, the available information and unavailability information are carried in Feedback User Info field where the unavailability information is announced by unavailability information start time, unavailability information duration. In some embodiments, the available information is the duration starting at the end of the ICF and ending at unavailability information start time. In some embodiments, the Feedback User Info field carries the available information and unavailability information and has the same length as a Special User Info field. In some embodiments, in the Feedback User Info field, the AID12 has value indicating the Feedback User Info field, B12 to B39 carry Type ID, available information and unavailable information, Trigger Dependent User Info, if exists, is reserved. In some embodiments, the ICF is Multi User Request to Send (MU-RTS) Trigger when carrying the available information and unavailable information, not soliciting available information and unavailable information. In some embodiments, the Feedback User Info field carries the available information and unavailability information and has the same length as a Special User Info field. In some embodiments, in the Feedback User Info field, the AID12 has value indicating the Feedback User Info field, B12 to B39 carry Type ID, available information and unavailable information, Trigger Dependent User Info, if exists, is reserved.

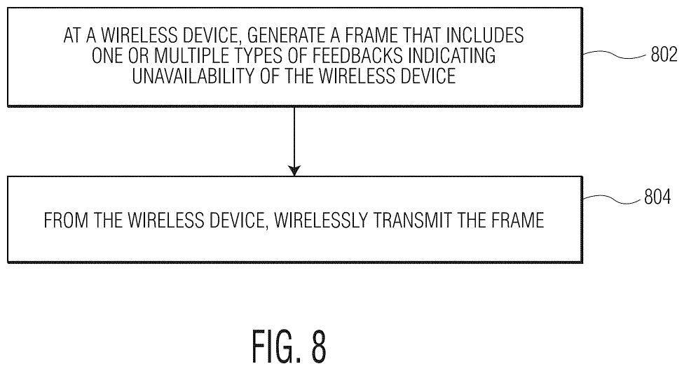

FIG. 8 is a process flow diagram of a method for wireless communications in accordance with an embodiment of the invention. At block 802, at a wireless device, a frame that includes one or multiple types of feedbacks indicating unavailability of the wireless device is generated. At block 804, from the wireless device, the frame is wirelessly transmitted. In some embodiments, each type of feedback of the one or multiple types of feedbacks is carried in its own feedback field, and wherein a feedback field in a Buffer Status Report Poll (BSRP) trigger frame includes a Feedback User Information (Info) field. In some embodiments, B12 to B15 of the Feedback User Info field indicate a type of a feedback in the Feedback User Info field, and B16 to B39 of the Feedback User Info field carry the feedback and optional reserved bits. In some embodiments, the feedback includes unavailability information that indicates an unavailable time period of the wireless device as a result of an existence or an occurrence of a wireless communications interference within the wireless device. In some embodiments, each type of feedback of the one or multiple types of feedbacks is carried in its own feedback field, and a feedback field in a Multi-Station (STA) Block Acknowledgement (BA) frame includes a Feedback Per Association Identification (ID) (AID) Traffic Identifier (TID) Information (Info) field. In some embodiments, 4 bits of Block Acknowledgement Starting Sequence Control indicate a type of a feedback in the Feedback Per AID TID Info field, and a Block Acknowledgement Bitmap field of in the Feedback Per AID TID Info field is repurposed to carry the feedback and optional reserved bits. In some embodiments, the feedback includes unavailability information that indicates an unavailable time period of the wireless device as a result of an existence or an occurrence of a wireless communications interference within the wireless device. In some embodiments the one or multiple types of feedbacks indicate the unavailability of the wireless device and/or the other type of feedbacks of the wireless device, and the other type of feedbacks of the wireless device include the bandwidth (BW) and number of spatial streams (Nss) of a dynamic power save (DPS) station (STA) that a DPS assisting AP intend to use for frame exchanges with the DPS STA and/or an internal interference indication that is used to indicate whether the reason that frames in a received Aggregated MAC Protocol Data Unit (A-MPDU) are not received correctly is an internal interference. In some embodiments, the wireless device includes a wireless access point (AP) or a wireless non-AP station (STA). In some embodiments, the wireless device includes a wireless access point (AP) that maintains at most one availability information of each station (STA). In some embodiments, when the wireless AP receives new unavailability information from a STA, the wireless AP discards previous unavailability information from the STA and maintains the new unavailability information from the STA. In some embodiments, the frame includes an initial control response (ICR) frame, and a Common Information field of an initial control frame (ICF) frame soliciting the ICR frame indicates whether or not the ICR frame is transmitted in a non-high throughput (HT) duplicate PPDU Physical Layer Protocol Data Unit (PPDU). In some embodiments, the ICF frame includes a Buffer Status Report Poll (BSRP) trigger frame, and the ICR frame includes a Multi-Station (STA) Block Acknowledgement (BA) frame. In some embodiments, the wireless device is compatible with an Institute of Electrical and Electronics Engineers (IEEE) 802.11 protocol. In some embodiments, the wireless device is a component of a multi-link device (MLD). The wireless device may be the same as or similar to an embodiment of the AP 106 depicted in FIG. 1, the APs 206-1, 206-2 depicted in FIG. 2, the wireless device 300 depicted in FIG. 3, and/or the wireless device 400 depicted in FIG. 4.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to generate a frame that comprises one or multiple types of feedbacks indicating unavailability of the wireless device; and
a wireless transceiver configured to wirelessly transmit the frame.

2. The wireless device of claim 1, wherein each type of feedback of the one or multiple types of feedbacks is carried in its own feedback field, and wherein a feedback field in a Buffer Status Report Poll (BSRP) trigger frame comprises a Feedback User Information (Info) field.

3. The wireless device of claim 2, wherein B12 to B15 of the Feedback User Info field indicate a type of a feedback in the Feedback User Info field, and wherein B16 to B39 of the Feedback User Info field carry the feedback and optional reserved bits.

4. The wireless device of claim 3, wherein the feedback comprises unavailability information that indicates an unavailable time period of the wireless device as a result of an existence or an occurrence of a wireless communications interference within the wireless device.

5. The wireless device of claim 1, wherein each type of feedback of the one or multiple types of feedbacks is carried in its own feedback field, and wherein a feedback field in a Multi-Station (STA) Block Acknowledgement (BA) frame comprises a Feedback Per Association Identification (ID) (AID) Traffic Identifier (TID) Information (Info) field.

6. The wireless device of claim 5, wherein 4 bits of Block Acknowledgement Starting Sequence Control indicate a type of a feedback in the Feedback Per AID TID Info field, and wherein a Block Acknowledgement Bitmap field of in the Feedback Per AID TID Info field is repurposed to carry the feedback and optional reserved bits.

7. The wireless device of claim 6, wherein the feedback comprises unavailability information that indicates an unavailable time period of the wireless device as a result of an existence or an occurrence of a wireless communications interference within the wireless device.

8. The wireless device of claim 1, wherein the one or multiple types of feedbacks indicate the unavailability of the wireless device and/or the other type of feedbacks of the wireless device, and wherein the other type of feedbacks of the wireless device comprise a bandwidth (BW) and number of spatial streams (Nss) of a dynamic power save (DPS) station (STA) that a DPS assisting AP intend to use for frame exchanges with the DPS STA or an internal interference indication that is used to indicate whether a reason that frames in a received Aggregated MAC Protocol Data Unit (A-MPDU) are not received correctly is an internal interference.

9. The wireless device of claim 1, wherein the wireless device comprises a wireless access point (AP) that maintains at most one availability information of each station (STA).

10. The wireless device of claim 9, wherein when the wireless AP receives new unavailability information from a STA, the wireless AP discards previous unavailability information from the STA and maintains the new unavailability information from the STA.

11. The wireless device of claim 1, wherein the frame comprises an initial control response (ICR) frame, and wherein a Common Information field of an initial control frame (ICF) frame soliciting the ICR frame indicates whether or not the ICR frame is transmitted in a non-high throughput (HT) duplicate PPDU Physical Layer Protocol Data Unit (PPDU).

12. The wireless device of claim 11, wherein the ICF frame comprises a Buffer Status Report Poll (BSRP) trigger frame, and wherein the ICR frame comprises a Multi-Station (STA) Block Acknowledgement (BA) frame.

13. The wireless device of claim 1, wherein the wireless device is compatible with an Institute of Electrical and Electronics Engineers (IEEE) 802.11 protocol.

14. The wireless device of claim 1, wherein the wireless device comprises a wireless multi-link device (MLD), and wherein the wireless transceiver is further configured to transmit the frame to a second wireless MLD through a wireless link between the wireless MLD and the second wireless MLD.

15. A method for wireless communications, the method comprising:
at a wireless device, generating a frame that comprises one or multiple types of feedbacks indicating unavailability of the wireless device; and
from the wireless device, wirelessly transmitting the frame.

16. The method of claim 15, wherein each type of feedback of the one or multiple types of feedbacks is carried in its own feedback field, and wherein a feedback field in a Buffer Status Report Poll (BSRP) trigger frame comprises a Feedback User Information (Info) field.

17. The method of claim 16, wherein B12 to B15 of the Feedback User Info field indicate a type of a feedback in the Feedback User Info field, and wherein B16 to B39 of the Feedback User Info field carry the feedback and optional reserved bits.

18. The method of claim 17, wherein the feedback comprises unavailability information that indicates an unavailable time period of the wireless device as a result of an existence or an occurrence of a wireless communications interference within the wireless device.

19. The method of claim 15, wherein each type of feedback of the one or multiple types of feedbacks is carried in its own feedback field, and wherein a feedback field in a Multi-Station (STA) Block Acknowledgement (BA) frame comprises a Feedback Per Association Identification (ID) (AID) Traffic Identifier (TID) Information (Info) field.

20. The method of claim 19, wherein 4 bits of Block Acknowledgement Starting Sequence Control indicate a type of a feedback in the Feedback Per AID TID Info field, and wherein a Block Acknowledgement Bitmap field of in the Feedback Per AID TID Info field is repurposed to carry the feedback and optional reserved bits.
